(19) United States
(12) Patent Application Publication
(10) Pub. No.: US 2009/0192547 A1
(43) Pub. Date: Jul. 30, 2009

(54) INFANT CHEW TOY

(76) Inventor: Cheryl Gates, Roosevelt, UT (US)

Correspondence Address: Kunzler & McKenzie, 8 EAST BROADWAY, SUITE 600, SALT LAKE CITY, UT, 84111, US

(21) Appl. No.: 12/022,312

(22) Filed: Jan. 30, 2008

(51) Int. Cl. A61J 17/00

(52) U.S. Cl. 606/235

(57) ABSTRACT

An infant chew toy apparatus includes an elongate handle and a flange or other lateral member disposed on the handle. The flange extends laterally from the handle. A protrusion is disposed on the flange. The protrusion may comprise a nipple, and may be oriented directionally opposite of and parallel to the handle. The flange may be disposed on an end of the handle, with another flange disposed on the opposite handle end. The apparatus is designed to make it convenient for infants to grip, chew, and pick up the apparatus, and portions of it may be constructed of suitably durable plastic or other material for teething purposes, with other portions constructed of softer material.

### BACKGROUND OF THE INVENTION

1. Field of the Invention

This invention relates to children's toys, and more particularly to infant chew toys.

2. Description of the Related Art

Many different types of infant chew toys exist, varying in shape, size, and appearance, to help infants get through teething. It has been discovered that it is beneficial for teething infants to impact and massage the gums and emerging teeth during the teething process, as a way to facilitate the emergence of teeth and to dull the pain associated with teething. Common types of chew toys include teething rings and rods. Most chew toys comprise rubber, plastic, or other material that is soft enough to avoid injury and yet hard enough to be effective as a teething device.

Apart from teething matters, chew toys give infants something to gnaw on generally, given their proclivity to put things in their mouths.

Many shapes and sizes of chew toys have a disadvantage in that they are difficult for the infant to obtain a grasp on. For example, it is often hard for an infant to pick a standard chew toy up off the floor or a high-chair tray. A standard teething ring lies flat when dropped and must be picked up by the edge, a difficult task for infants. It can also be difficult for the infant to maintain a firm grip on the chew toy. Many chew toys have a single, uniform consistency with regard to how hard or soft they are.

Before or while teething occurs, infants are often given pacifiers, i.e., apparatuses with soft rubber or plastic nipples that give an infant something to suck, which fills a natural inclination of infants and soothes them. In comparison with chew toys, pacifiers are generally small apparatuses, containing just enough structure surrounding the pacifier nipple to keep an infant from swallowing the pacifier and to make it convenient to install and remove the nipple from the infant's mouth.

The material used to construct a chew toy is often different, particularly with regard to hardness, than that of a pacifier.

### SUMMARY OF THE INVENTION

The present invention has been developed in response to the present state of the art, and in particular, in response to the problems and needs in the art that have not yet been fully solved by currently available infant chew toys. Accordingly, the present invention has been developed to provide an infant chew toy that overcomes many or all shortcomings in the art.

In one aspect of the invention, an embodiment of an infant toy apparatus includes an elongate handle and a flange disposed on the handle. The flange may be disposed at a first end of the handle, with a protrusion attached to and extending from the side of the flange opposite the handle. The protrusion may be approximately parallel to the handle, and may comprise a nipple. The flange may be circular or have indentations to form other shapes such as a heart, flower, etc. Bristles may be disposed on one end of the handle, and the handle may include a grip configured to facilitate an infant's grip of the handle.

In a further aspect of the invention, an embodiment of an infant toy apparatus includes an elongate handle, a lateral member extending laterally outward from a first end of the handle, and a protrusion extending from the lateral member. The protrusion is approximately parallel to the handle. In one embodiment, the lateral member is approximately planar, the handle attaches to the lateral member approximately in the center, and the protrusion attaches to the side of the lateral member opposite the handle approximately in the center of the lateral member.

In a further aspect of the invention, an embodiment of an infant chew toy apparatus includes an elongate handle having a first end and a second end, with a first flange disposed at the first end, a second flange disposed at the second end, and a first nipple disposed on the first flange. The first nipple extends away from and is approximately parallel to the handle. A second nipple disposed on the second flange also extends away from and is approximately parallel to the handle. The apparatus may be constructed of flexible or stiff material such as molded plastic. In one embodiment, a portion of the apparatus is hollow, and a substance, e.g., teething medicine, is disposed within the hollow portion of the apparatus. The handle may extend approximately diagonally or in other orientations between the first and second flanges.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Discussion of the features and advantages, and similar language, throughout this specification may, but do not necessarily, refer to the same embodiment.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments illustrated in the appended drawings, which depict only typical embodiments of the invention and are not to be considered limiting of its scope, in which:

FIG. 1 is a side elevational view of one embodiment of an infant chew toy according to the present invention;

FIG. 2 is a side elevational view of another embodiment of an infant chew toy according to the present invention;

FIG. 3 is a side elevational view of another embodiment of an infant chew toy according to the present invention;

FIG. 4 is a side elevational view of another embodiment of an infant chew toy according to the present invention;

FIG. 5 is a side elevational view of another embodiment of an infant chew toy according to the present invention;

FIGS. 6A-6G are front elevational views of various embodiments of infant chew toys according to the present invention, showing differently shaped end pieces;

FIG. 7 is a front elevational view of another embodiment of an infant chew toy according to the present invention;

FIG. 8 is a side elevational view of another embodiment of an infant chew toy according to the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

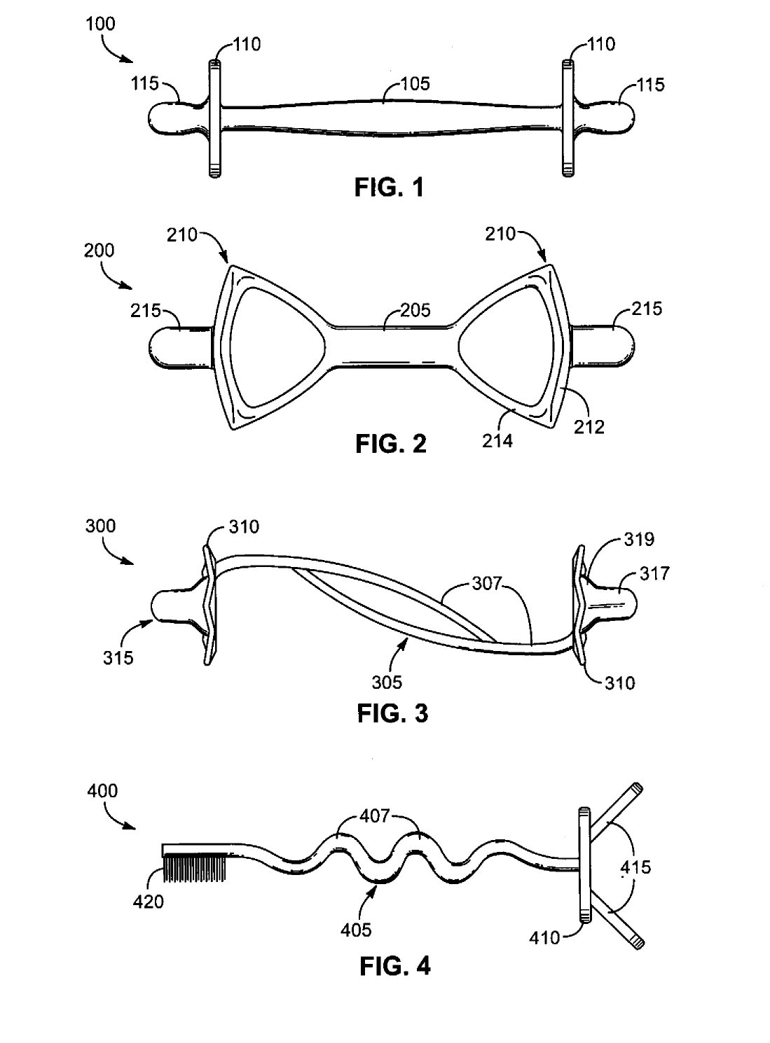

FIG. 1 shows one embodiment of an infant chew toy 100 according to the present invention, comprising an elongate cylindrical handle 105, end pieces 110 disposed on opposite ends of the handle 105, and nipples 115 disposed on the end pieces 110 oppositely of the handle 105. The end pieces 110 comprise flanges or lateral members which extend laterally or radially from the handle 105. In one embodiment, the toy 100 is constructed from molded plastic, rubber, or other flexible or semi-flexible material. It can also be constructed from hard plastic or similar material. The nipples 115 and other components can be constructed from the same material as the rest of the toy 100, or may be made of different (e.g., harder or softer) material. The nipples 115 may be hollow, with walls that are relatively thin compared to the rest of the toy 100, making them more pliable and suitable for sucking.

In use, an infant can more easily pick up the toy 100 as compared to prior art devices, since the end pieces 110 prevent the handle 105 from lying flat on the floor or other surface. The infant can bite on the end pieces 110 and bite on or suck one of the nipples 115, giving the toy 100 the added function of a pacifier, not only providing relief of teething pain but also soothing the infant by sucking. The end pieces 110 and nipples 115, separately and together, give the toy 100 added surfaces and projections, making it easier for the infant to maintain its grip and giving it a more varied experience with regard to handling and chewing.

If desired, the end pieces 110 may not extend laterally all the way around the handle 105, as described further below.

One or more components of the toy 100 may be made to be hollow to house a substance to attract the attention of the infant or provide other experience for it, such as a brightly colored fluid, a collection of glitter granules, or other substance. Hollow portions of the toy 100 may also contain an edible substance such as teething medicine, which the infant may obtain through small holes disposed in the toy 100. Access may also be provided by making the toy from a degradable or edible substance, such as a hard candy, providing access to the teething medicine as the toy material erodes away. The nipples 115 may be provided with a small hole, such as that found in a standard infant feeding bottle, to provide access to the teething medicine or other substance disposed within the toy 100.

FIG. 2 shows another embodiment of an infant chew toy 200 according to the present invention, comprising a handle 205, end pieces 210 disposed on opposite ends of the handle 205 and extending laterally therefrom, and protrusions 215 disposed on the end pieces 210 oppositely of the handle 205. Each end piece 210 comprises a flange 212 and a forked support member 214 connecting the handle 205 to the flange 212. The forked support member 214 may be considered part of the handle 205 rather than the end piece 210, depending on its structure.

Unlike the nipples 115, the protrusions 215 are not designed for sucking on by the infant, but for providing further projections for gripping purposes as well as another surface to gnaw on for teething purposes. (Note that the nipples 115 are themselves protrusions, but of a special type.) The protrusions 215 are oriented parallel to the handle 205.

FIG. 3 shows another embodiment of an infant chew toy 300 according to the present invention, comprising a handle 305, end pieces 310 disposed on opposite ends of the handle 305 and extending laterally therefrom, and protrusions 315 disposed on the end pieces 310 oppositely of the handle 305. The handle 305 is oriented approximately diagonally between the end pieces 310 and is constructed of two curved pieces 307, which mate to the end pieces 310 and to each other. Each protrusion 315 is shaped like a pacifier, with a nipple 317 and base 319.

FIG. 4 shows another embodiment of an infant chew toy 400 according to the present invention, comprising a handle 405, an end piece 410 disposed on one end of the handle 405 and extending laterally therefrom, protrusions 415 disposed on the end piece 410, and bristles 420 disposed on the opposite end of the handle 405. The handle 405 contains bends 407. The protrusions 415 are attached to the end piece 410 and are oriented diagonally away from the end piece 410.

In use, the bends 407 make it easier for an infant to grip the handle 405. The bends also help keep the handle 405 from lying flat on a surface, making it easier for an infant to pick up. The protrusions 415 provide additional structure for the infant to grip and gnaw on. The bristles 420, configured much like a standard toothbrush in one embodiment, give the infant a varied chewing experience, providing different texture and softness to the toy 400.

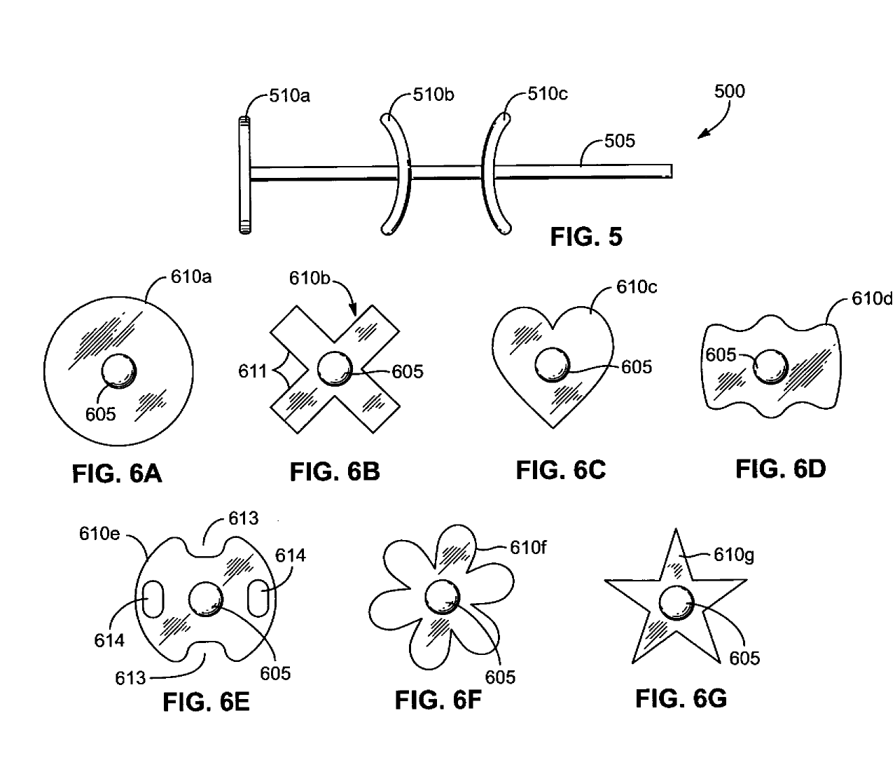

FIG. 5 shows another embodiment of an infant chew toy 500 according to the present invention, comprising a handle 505 and laterally extending pieces or members 510 disposed on the handle. Lateral member 510a comprises a planar flange disposed on an end of the handle 505. Lateral member 510b comprises a curved flange (which may be considered approximately if not exactly planar) disposed an axial distance along the handle 505 from the lateral member 510a. Lateral member 510c comprises a flange, curved in an opposite direction from the lateral member 510b, disposed a further axial distance along the handle 505 from the lateral member 510b.

In use, the lateral members 510 provide additional surfaces for an infant to grip and chew on. They break up the length of the handle 505, and provide structure to help an infant pick the toy 500 up off a flat surface.

FIGS. 6A-6G show various embodiments of end pieces 610, as seen from the front. The end pieces 610 may be of varying thicknesses. They may comprise flanges, as described above, or other types of lateral members. The figures each show the end of a handle 605 attaching to the end pieces 610. As shown, the handle 605 attaches approximately in the center of the end pieces 610, though it may attach at other locations such as near an edge of the end pieces 610 (an example of which is depicted in FIG. 3).

FIG. 6A shows an end piece 610a that is circular as seen from the front. The end piece 610a may be a circular disc, a cylinder, a sphere, or other shape.

FIG. 6B shows an end piece 610b that is X-shaped, comprising four elongated lateral members 611 extending laterally from the handle 605. The end piece 610b is an example of an end piece that does not extend laterally all the way around the handle 605.

FIG. 6C shows an end piece 610c that is heart-shaped.

FIG. 6D shows an end piece 610d having a basic rectangular shape, being modified by rounded corners and corrugated edges for safety and variety.

FIG. 6E shows an end piece 610e having a basic circular shape, but containing concave portions 613 and decorative holes 614.

FIG. 6F shows an end piece 610f in the shape of a flower.

FIG. 6G shows an end piece 610g in the shape of a star.

As can be seen, the end pieces 610b-610g shown in FIGS. 6B-6G all have indentations disposed on their edges, as opposed to the circular shape of the end piece 610a, the types and degree of indentation helping define the shape of the particular end piece.

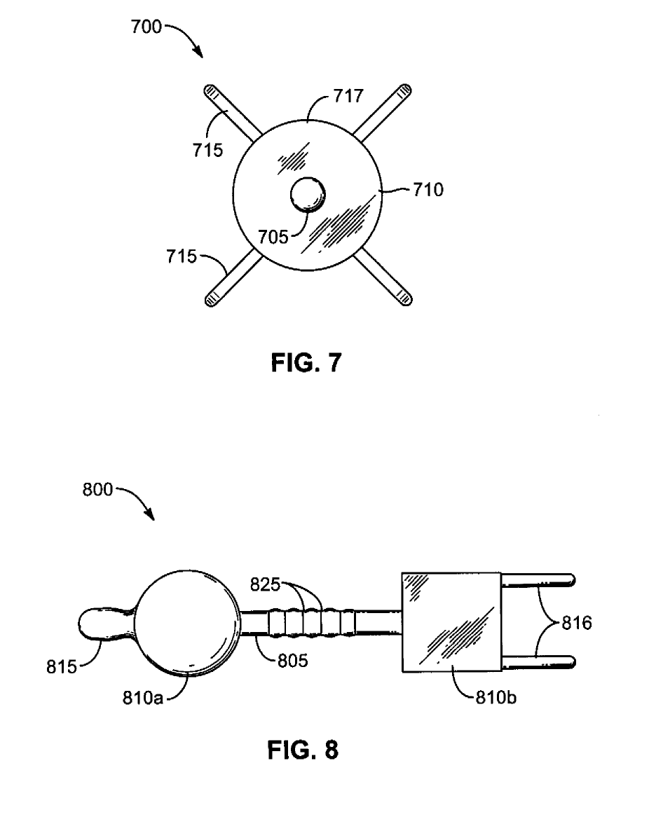

FIG. 7 shows another embodiment of an infant chew toy 700 according to the present invention. The toy 700 comprises a handle 705, an end piece 710 disposed on one end of the handle 705, the end piece 710 extending laterally from the handle, and protrusions 715 disposed on the end piece 710. The protrusions 715 are disposed on the edge 717 of the end piece 710, and extend laterally therefrom, providing additional surfaces for an infant to grasp and/or chew on.

FIG. 8 shows another embodiment of an infant chew toy 800 according to the present invention. The toy 800 comprises a handle 805, a spherical end piece 810a disposed on one end of the handle 805, a cube-shaped end piece 810b disposed on the opposite end of the handle 805, a nipple 815 disposed on the spherical end piece 810a, and protrusions 816 disposed on the cube-shaped end piece 810b. A grip 825 is disposed on the handle 805, the grip 825 comprising a series of ridges for easier gripping of the toy 800 by an infant. The grip 825 may be constructed of relatively soft material to facilitate grasping of the toy 800 by an infant. Any structure that textures, roughens, or otherwise alters the smooth cylindrical handle shape exemplified by handle 105 may be considered a grip; e.g., the bends 407 of the handle 405, the shape of the handle 305 created by the joinder of the two curved pieces 307, or other alterations.

Given their relative thicknesses, the end pieces 810a are particularly suited for housing of a hollow chamber and filling of the chamber with fluid, candy, granules, teething medicine, or other substance, if desired.

The present invention may be embodied in other specific forms without departing from its essential characteristics. The described embodiments are to be considered in all respects only as illustrative and not restrictive. The invention illustrated by the embodiments described above is not limited to infants' chew toys; rather, it includes general toys and similar apparatuses. The scope of the invention is indicated by the appended claims rather than by the foregoing description. All changes which come within the meaning and range of equivalency of the claims are to be embraced within their scope.

What is claimed is:

1. An infant toy apparatus comprising:
an elongate handle;
a flange disposed on the handle.

2. The apparatus of claim 1, wherein the flange is disposed at a first end of the handle.

3. The apparatus of claim 2, wherein the flange has first and second opposing sides, with the handle attaching to the first side, and further comprising a protrusion attached to and extending from the second side.

4. The apparatus of claim 3, wherein the protrusion is approximately parallel to the handle.

5. The apparatus of claim 3, wherein the protrusion comprises a nipple.

6. The apparatus of claim 1, wherein the flange is circular.

7. The apparatus of claim 1, further comprising indentations disposed on the edge of the flange.

8. The apparatus of claim 2, further comprising a plurality of bristles disposed at a second end of the handle.

9. The apparatus of claim 1, wherein the handle comprises a grip configured to facilitate grip of the handle.

10. An infant toy apparatus comprising:
an elongate handle;
a lateral member extending laterally outward from a first end of the handle;
a protrusion extending from the lateral member, the protrusion being approximately parallel to the elongate handle.

11. The apparatus of claim 8, wherein the protrusion comprises a nipple.

12. The apparatus of claim 8, wherein the lateral member has first and second opposing sides, with the handle attaching to the first side and the protrusion attaching to the second side.

13. The apparatus of claim 12, wherein the lateral member is approximately planar and the handle attaches to the first side approximately in the center of the lateral member.

14. The apparatus of claim 13, wherein the protrusion attaches to the second side approximately in the center of the lateral member.

15. An infant chew toy apparatus comprising:
an elongate handle having a first end and a second end;
a first flange disposed at the first end;
a second flange disposed at the second end;
a first nipple disposed on the first flange, the first nipple extending away from the handle and extending approximately parallel to the handle;
a second nipple disposed on the second flange, the second nipple extending away from the handle and extending approximately parallel to the handle.

16. The apparatus of claim 15, wherein the apparatus is constructed of flexible material.

17. The apparatus of claim 15, wherein the apparatus is constructed of molded plastic.

18. The apparatus of claim 15, wherein a portion of the apparatus is hollow and further comprising a substance disposed within the hollow portion of the apparatus.

19. The apparatus of claim 18, wherein the substance comprises teething medicine.

20. The apparatus of claim 15, wherein the handle extends approximately diagonally between the first and second flanges.
